(19) United States
(12) Patent Application Publication
(10) Pub. No.: US 2021/0109056 A1
(43) Pub. Date: Apr. 15, 2021

(54) Electrochemical Gas Sensor

(71) Applicant: TDK Corporation, Tokyo (JP)

(72) Inventors: Andreas Barbul, München (DE); Matthias König, München (DE)

(21) Appl. No.: 17/033,128

(22) Filed: Sep. 25, 2020

(30) Foreign Application Priority Data
Oct. 15, 2019 (DE) 102019127748.5

(51) Int. Cl. G01N 27/407

(52) U.S. Cl. CPC G01N 27/4073; G01N 27/4075

(57) ABSTRACT

In an embodiment an electrochemical gas sensor includes a base plate comprising a base plate main surface, a catalytic layer configured to enhance chemical reactivity of gases, the catalytic layer is arranged on top of the base plate main surface and a solid electrolyte layer arranged on top of the catalytic layer, wherein the solid electrolyte layer comprises a ceramic material, and wherein the catalytic layer and the solid electrolyte layer are electrically contacted by contacts.

### CROSS-REFERENCE TO RELATED APPLICATIONS

This application claims priority to German Patent Application No. 102019127748.5, filed on Oct. 15, 2019, which application is hereby incorporated herein by reference.

### TECHNICAL FIELD

The invention relates to an electrochemical gas sensor comprising a solid electrolyte layer.

### BACKGROUND

Electrochemical gas sensors are widespread devices for the detection of gases. Typical electrochemical gas sensors are fuel cells which comprise a liquid electrolyte. The liquid electrolyte requires a certain volume which makes the electrochemical gas sensor relatively large in size. As electrochemical gas sensors which are smaller in size than commonly used electrochemical gas sensors are desired, new electrochemical gas sensors are required.

### SUMMARY

Embodiments provide an improved electrochemical gas sensor which is designed to be smaller in size than commonly used electrochemical gas sensors.

Embodiments provide an electrochemical gas sensor comprising a base plate which features a base plate main surface, wherein a catalytic layer which enhances the chemical reactivity of gases, is deposited on top of the base plate main surface, wherein a solid electrolyte layer is deposited on top of the catalytic layer, wherein the solid electrolyte layer comprises a ceramic material, and wherein the catalytic layer and the solid electrolyte layer are electrically contacted by contacts.

The base plate comprises at least one substrate comprising a substrate main surface. It is also possible that the base plate comprises the substrate and one or more additional layers which are deposited on top of the substrate main surface. In the case that additional layers have been applied to the substrate main surface, the base plate main surface is the main surface of the uppermost additional layer. In the case that no additional layers have been applied to the substrate main surface, the substrate main surface represents the base plate main surface.

The use of a solid electrolyte instead of a liquid electrolyte has the benefit that the electrolyte can be formed as a thin layer. This reduces the size of the overall electrochemical gas sensor.

Moreover, the use of a ceramic material as a main component of the solid electrolyte layer has the advantage that the gas, which has to be detected, can easily reach the catalytic layer due to the porosity of the ceramic material.

Here and in the following a catalytic layer is a layer which enhances the reactivity of gases. In particular, the catalytic layer promotes the splitting of gas molecules into electrically charged species, such as ions. Those electrically charged species are transported to the contacts of the electrochemical gas-sensor via the solid electrolyte creating an electrical current. As the magnitude of the created electrical current is typical for the gas, which has reacted at the catalytic layer, the specific type of gas can be determined.

Moreover, the electrochemical gas sensor may comprise a gas-sensitive layer which is arranged between the base plate main surface and the catalytic layer. In other words, the gas-sensitive layer is sandwiched between the base plate main surface and the catalytic layer.

The gas-sensitive layer is a layer which features an electric conductivity, which can be influenced by gas molecules being in contact with the gas-sensitive layer. Hence, it is possible to detect a certain gas by the variations of the electrical conductivity which are caused by this certain gas.

The gas-sensitive layer may comprise a thermistor ceramic or a metal oxide which is selected from a group of metal oxides comprising tin oxide, zinc oxide and copper oxide.

Due to the combination of the catalytic layer and the gas-sensitive layer with the solid electrolyte layer it may be possible to detect at least two different gases simultaneously. In order words, the catalytic layer may be adapted to detect a first gas, wherein the gas-sensitive layer may be adapted to detect a second gas, which is different from the first gas. Accordingly, two different gas sensors for detecting two different gases are no longer required. This leads to a miniaturization of the whole gas sensor.

The electrochemical gas sensor may comprise an electrode layer which is deposited on top of the solid electrolyte layer. This electrolyte layer creates a homogeneous electrical field within the solid electrolyte layer supporting the transport of the electrically charged species which have been formed due to the reaction of gases at the catalytic layer. Accordingly, the efficiency of the electrochemical gas sensor is enhanced.

Moreover, the solid electrolyte layer of the electrochemical gas sensor may comprise a ceramic material which is ion conductive and/or electrically conductive. This conductivity enhances the transport of the electrically charged species to the contacts.

Furthermore, the solid electrolyte layer of the electrochemical gas sensor may comprise a ceramic material which is a piezoelectric ceramic material. A piezoelectric ceramic material is able to change its crystal structure when an electrical field is applied. This change in the crystal structure affects the ion conductivity and/or electrical conductivity of the material. In other words, it is possible to transfer the piezoelectric ceramic material from a state of high conductivity to a state of low conductivity and vice versa just by applying an electrical field. This leads to a switchable electrochemical gas sensor.

Furthermore, the catalytic layer of the electrochemical gas sensor may comprise at least one metal or one oxide thereof, the metal being selected from a group of metals comprising platinum, palladium, silver, gold and copper. These metals are typically used to enhance the reactivity of gases.

Moreover, the gas-sensitive layer, the catalytic layer, the solid electrolyte layer and/or the electrode layer may feature a plurality of holes which may have been made by laser drilling for example. These holes increase the porosity of each layer and therewith increase the surface area of each layer. An increased porosity leads to an increased permeability of each layer to gases. This makes it easier for the gas to reach each layer of the electrochemical gas sensor. Moreover, a high surface area increases the accessible surface area for the gas in each layer. Due to these two effects of the plurality of holes, the efficiency of the electrochemical gas sensor can be enhanced.

The use of laser drilling as a method of forming the holes allows relatively small holes to be created compared to other drilling methods, leading to higher possible porosities and larger possible surface areas compared to those possible with other drilling methods.

In another embodiment of the electrochemical gas sensor the base plate may comprise a heating device to enhance the performance of the electrochemical gas sensor. The heating device delivers additional terminal energy to the electrochemical gas sensor stack which enhances the reactivity of the gases which are in contact with the gas sensor stack.

Here and in the following a gas sensor stack is an arrangement of the different layers of the electrochemical gas sensor as described above. The gas sensor stack may comprise only the catalytic layer and the solid electrolyte layer or the catalytic layer, the solid electrolyte layer and the gas-sensitive layer or the gas-sensitive layer, the catalytic layer, the solid electrolyte layer and the electrode layer.

Furthermore, at least two electrochemical gas sensors may be combined to form an electrochemical gas sensor array.

### BRIEF DESCRIPTION OF THE DRAWINGS

In the following different embodiments of an electrochemical gas sensor are explained in more detail with the aid of drawings. Components of drawings which are similar to each other feature the same reference signs.

FIG. 1 illustrates a cross-sectional view of an electrochemical gas sensor;

FIG. 2 illustrates a cross-sectional view of another electrochemical gas sensor;

FIG. 3 illustrates a cross-sectional view of another electrochemical gas sensor;

FIG. 4 illustrates a cross-sectional view of another electrochemical gas sensor; and

FIG. 5 illustrates a top view of an electrochemical gas sensor.

### DETAILED DESCRIPTION OF ILLUSTRATIVE EMBODIMENTS

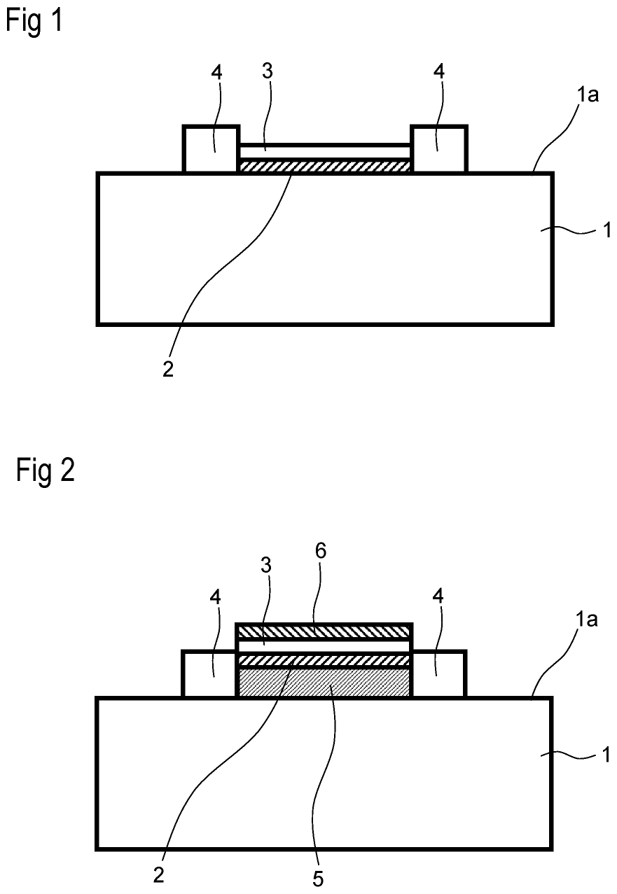

FIG. 1 illustrates, in a cross-sectional view, an electrochemical gas sensor comprising a base plate 1, a catalytic layer 2 and a solid electrolyte layer 3. The catalytic layer 2 is deposited on top of a base plate main surface 1a. The solid electrolyte layer 3 is deposited on top of the catalytic layer 2. The catalytic layer 2 and the solid electrolyte layer 3 are electrically contacted by contacts 4. The catalytic layer 2 comprises a metal selected from a group of metals comprising platinum, silver, gold and copper. The solid electrolyte layer 3 comprises a ceramic material which is ion conductive and/or electrically conductive. The ceramic material may also be a piezoelectric ceramic material. Both layers feature a plurality of holes which have been made by laser drilling (not depicted). The gas to be detected reaches the electrochemical gas sensor at the side opposite to the base plate 1. Due to the porosity of the solid electrolyte layer 3, the gas can easily come in contact with the catalytic layer 2. At the catalytic layer 2 the gas molecules of the gas to be detected are split in electrically charged species which are transported by the solid electrolyte layer 3 to the contacts 4. This creates an electrical current which is specific for the gas to be detected. Accordingly, the gas to be detected can be identified.

FIG. 2 illustrates, in a cross-sectional view, an electrochemical gas sensor similar to that shown in FIG. 1 wherein a gas-sensitive layer 5 is arranged between the base plate main surface 1a and the catalytic layer 2. Furthermore, an electrode layer 6 is deposited on top of the solid electrolyte layer 3. The introduction of the gas-sensitive layer 5 makes it possible to introduce another measurement principle into the electrochemical gas sensor. Accordingly, it is possible to detect at least two different gases simultaneously with the electrochemical gas sensor. Due to the electrode layer 6 it is possible to create a homogenous electrical field into the solid electrolyte layer 3, increasing the ability of the solid electrolyte layer 3 to transport the electrically charged species, which have been created at the catalytic layer 2, through the solid electrolyte layer 3 towards the contacts 4. This enhances the performance of the electrochemical gas sensor.

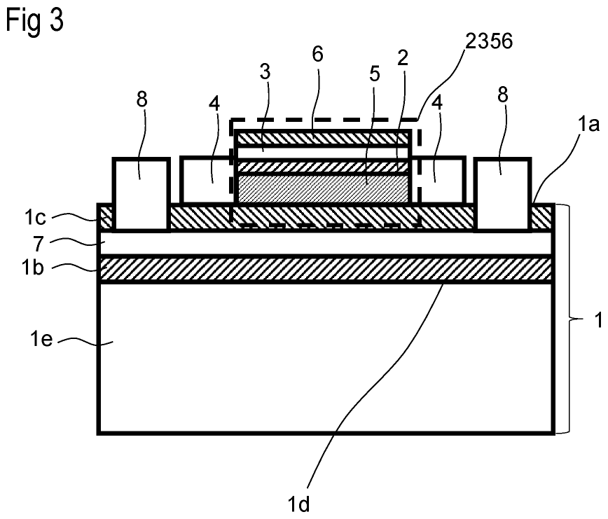

FIG. 3 illustrates, in a cross-sectional view, an electrochemical gas sensor which is similar to that shown in FIG. 2 wherein the base plate 1 comprises a heating device 7. The heating device 7 is incorporated in the base plate 1 in such a way that a membrane 1b is arranged on top of a substrate main surface 1d of a substrate 1e. The heating device 7 is arranged on top of the membrane 1b. Moreover, an insulating layer 1c is arranged on top of the heating device 7. The insulating layer 1c prevents an electrically conductive contact between the electrochemical gas sensor stack 2356 and the heating device 7. The heating device 7 delivers additional thermal energy to the electrochemical gas sensor stack 2356, enhancing the reactivity of the gases reaching the electrochemical gas sensor stack 2356. Accordingly, the performance of the whole electrochemical gas sensor can be enhanced.

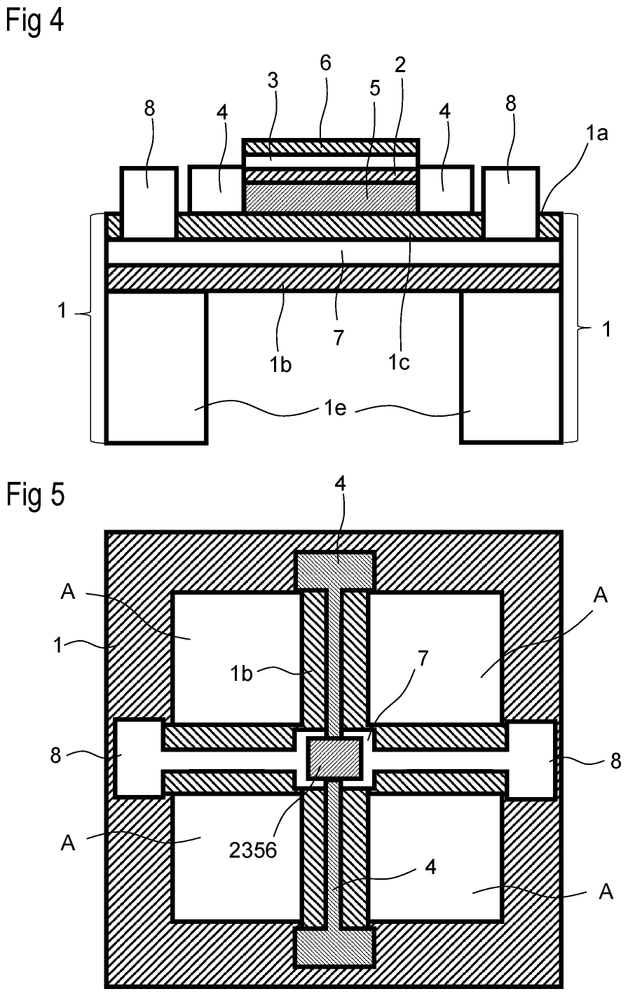

FIG. 4 illustrates, in a cross-sectional view, an electrochemical gas sensor wherein the substrate 1e and the membrane 1b have been partially etched away.

FIG. 5 illustrates, in a top view, an electrochemical gas sensor which is similar to that shown in FIG. 4. It can be seen that a significant part of the base plate 1 is not present anymore. Only two bars of the membrane 1b, which are arranged like a cross, are left. The areas A indicate empty space. The electrochemical gas sensor stack 2356 is arranged in the center of the cross. This embodiment of the electrochemical gas sensor has the benefit that accessibility of the gas to be detected to the electrochemical gas sensor stack 2356 is improved. This enhances the performance of the whole gas sensor.

The electrochemical gas sensor is not limited to the embodiments given in the figures. In particular the arrangement of the single components of the electrochemical gas sensor may vary.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An electrochemical gas sensor comprising:
a base plate comprising a base plate main surface;
a catalytic layer configured to enhance chemical reactivity of gases, the catalytic layer is arranged on top of the base plate main surface; and
a solid electrolyte layer arranged on top of the catalytic layer,
wherein the solid electrolyte layer comprises a ceramic material, and
wherein the catalytic layer and the solid electrolyte layer are electrically contacted by contacts.

2. The electrochemical gas sensor according to claim 1, further comprising a gas-sensitive layer arranged between the base plate main surface and the catalytic layer.

3. The electrochemical gas sensor according to claim 2, wherein the gas-sensitive layer comprises a thermistor ceramic or a metal oxide, and wherein the metal oxides comprises tin oxide, zinc oxide or copper oxide.

4. The electrochemical gas sensor according to claim 2, wherein the electrochemical gas sensor is configured to detect two or more different gases simultaneously.

5. The electrochemical gas sensor according to claim 1, further comprising an electrode layer arranged on top of the solid electrolyte layer.

6. The electrochemical gas sensor according to claim 1, wherein the ceramic material of the solid electrolyte layer is ion conductive and/or electrically conductive.

7. The electrochemical gas sensor according to claim 1, wherein the ceramic material of the solid electrolyte layer is a piezoelectric ceramic material.

8. The electrochemical gas sensor according to claim 1, wherein the catalytic layer comprises at least one metal or one metal oxide, and wherein the metal comprises platinum, palladium, silver, gold or copper.

9. The electrochemical gas sensor according to claim 1, wherein a gas-sensitive layer, the catalytic layer, a solid electrolyte layer and/or a electrode layer comprises a plurality of holes.

10. The electrochemical gas sensor according to claim 1, wherein the base plate comprises a heating device configured to enhance performance of the electrochemical gas sensor.

11. An electrochemical gas sensor array comprising:
at least two electrochemical gas sensors according to claim 1.
